(19) United States
(12) Patent Application Publication
(10) Pub. No.: US 2025/0198203 A1
(43) Pub. Date: Jun. 19, 2025

(54) VEHICLE DOOR HANDLE ASSEMBLY

(71) Applicant: Minebea AccessSolutions France, Alfortville (FR)

(72) Inventor: Marvin GINIES, Alfortville (FR)

(73) Assignee: Minebea AccessSolutions France, Alfortville (FR)

(21) Appl. No.: 18/974,896

(22) Filed: Dec. 10, 2024

(30) Foreign Application Priority Data
Dec. 15, 2023 (EP) 23315457.4

(51) Int. Cl. E05B 79/06

(52) U.S. Cl. CPC E05B 79/06

(57) ABSTRACT

A vehicle door handle can be fastened to a bracket fixed on an inner side of a vehicle door panel. The door handle moves between a retracted position flush with an outer side of the vehicle door panel and a deployed position. The door handle includes a structure having a first sleeve to be fastened to a first lever of the bracket and a second sleeve to be fastened to a second lever of the bracket, and a cover to be fastened to the structure. The cover includes first and second arms for covering the first and second sleeves, respectively. The first and second arms respectively include first and second hooks to be introduced in first and second slots arranged in a wall of the first and second sleeves to ensure the alignment of the first and second arms with the first and second sleeves.

### TECHNICAL FIELD

The present invention relates to the field of vehicle door handles to control the opening of vehicle doors and in particular to retractable vehicle door handles configured for moving from a retractable position wherein the handle flushes with the outer side of the door panel to reduce drag when the vehicle is moving and a deployed position wherein the handle can be grabbed by a user to open the door.

### BACKGROUND OF THE INVENTION

The vehicle door handle assembly usually comprises a bracket fixed to the inner side of the vehicle door panel and a retractable or movable handle which is configured to be fastened to the bracket. The movable handle is configured to be displaced between a retractable position where it flushes with the outer side of the door panel and a deployed position where it can be grabbed by the user.

The movable handle comprises a structure comprising the technical parts of the handle such as the fastening means of the movable handle to the bracket and a cover configured to be fastened to the structure to hide the technical parts and to provide the desired aesthetic appearance. In order to provide a smooth appearance, in particular in the deployed position, it is required that the cover be aligned with the structure without any gap or float. It is also required that the assembly of the cover to the structure be easy to be adapted to the large-scale production of the automotive industry.

### SUMMARY OF THE INVENTION

It is therefore an aim of the present invention to provide a solution enabling assembling the cover to the structure of the movable handle in an easy way while ensuring the alignment of the cover with the structure without float to keep a smooth visual appearance.

Thus, the present invention refers to a vehicle door handle configured to be fastened to a bracket fixed on an inner side of a vehicle door panel, the said door handle being configured for moving between a retracted position wherein the door handle flushes with an outer side of the vehicle door panel and a deployed position,

wherein the door handle comprises a structure comprising a first sleeve configured to be fastened to a first lever of the bracket and a second sleeve configured to be fastened to a second lever of the bracket and a cover configured to be fastened to the structure, the said cover comprising a first arm configured for covering the first sleeve and a second arm configured for covering the second sleeve wherein the first arm comprises a first hook configured to be introduced in a first slot arranged in a wall of the first sleeve to ensure the alignment of the first arm with the first sleeve and the second arm comprises a second hook configured to be introduced in a second slot arranged in a wall of the second sleeve to ensure the alignment of the second arm with the second sleeve, the inner side of the wall associated with the slots of the first and second sleeves defining a chamfer with an angle comprised between 20° and 60°, notably 45° and wherein the first and the second hooks have a shape complementary with the respective chamfers to ease the introduction of the hooks within the respective slots.

The combination of a slot with an internal chamfer and a hook with a tilt complementary with the chamfer ensures the insertion of the hook within the slot when the cover is slid along the structure.

According to another aspect of the present invention, the cover has a U-shape cross-section, a first branch of the U comprising the first and second arms of the door handle and a second branch of the U opposing the first branch, the first and second branches of the U extending towards each other with an angle comprise between 5 and 30°.

According to another aspect of the present invention, the first branch of the U is longer than the second branch.

According to another aspect of the present invention, the structure and the cover comprise clipping means for fastening the cover to the structure.

According to another aspect of the present invention, the cover is glued to the structure.

According to another aspect of the present invention, the structure comprises guiding rails configured for guiding the hooks of the cover towards the slots during assembly.

According to another aspect of the present invention, the cover is made of plastic material.

The present invention also refers to a vehicle door handle assembly comprising a bracket configured to be fixed on the inner side of a vehicle door panel and a door handle in accordance with one of the previous claims wherein the bracket comprises a first and a second levers configured for receiving the door handle.

The present invention also refers to a method for assembling a vehicle door handle according to one of the previous claims, the method comprising the following steps:
positioning the cover next to the structure with the first and second hooks positioned respectively in front of the first and second slots,
sliding the cover along the structure in order for the first and second hooks of the cover to be introduced in the respective first and second slots of the structure,
clipping the cover to the structure.

According to another aspect of the present invention, during the sliding step, the hooks of the cover are displaced along the guiding rails towards the respective first and second slots of the structure.

### BRIEF DESCRIPTION OF THE DRAWINGS

FIG. 1a is a top view of a door handle structure according to an embodiment of the present invention;

FIG. 1b is a bottom view of a door handle cover according to an embodiment of the present invention;

FIG. 2 is a cross-sectional view of the cover and the structure of the handle according to an embodiment of the present invention.

FIG. 3 is a cut and side view of a hook of the handle's cover and an associated slot of the handle's structure according to an embodiment of the present invention;

FIG. 4 is a perspective view of the hook of FIG. 3;

FIG. 5a is the hook and slot of FIG. 3 in a first position;

FIG. 5b is the hook and slot of FIG. 3 in a second position;

FIG. 5c is the hook and slot of FIG. 3 in an assembled position;

FIG. 6 is a perspective view of a part of the cover assembled to the structure;

FIG. 7 is a flowchart of the different of a method for assembling a vehicle door handle according to an embodiment of the present invention;

### DETAILED DESCRIPTION OF THE INVENTION

The following achievements are examples. Although, the specification refers to one or several embodiments, it does not imply that each reference refers to the same embodiment or that the features apply only to a single embodiment. Simple features of different embodiments can also be combined to provide other embodiments.

In the following of the description, the terms up, low, vertical, horizontal refers to relative positions or directions when the door handle is assembled to a vehicle.

The present invention refers to a vehicle door handle 1 configured to be fastened to a bracket fixed on an inner side of a vehicle door panel. The handle 1 is a movable handle 1 configured for moving between a retracted position wherein the door handle 1 flushes with an outer side of the vehicle door panel and a deployed position wherein the user can grasp the handle 1 to pull the handle 1 to open the door.

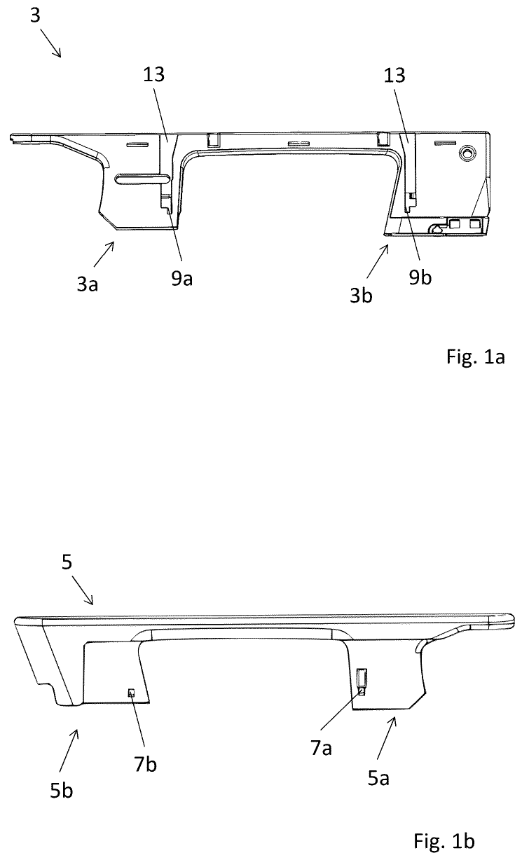

The handle 1 comprises a structure 3, as represented in FIG. 1a, comprising a first sleeve 3a configured to be fastened to a first lever of the bracket and a second sleeve 3b configured to be fastened to a second lever of the bracket.

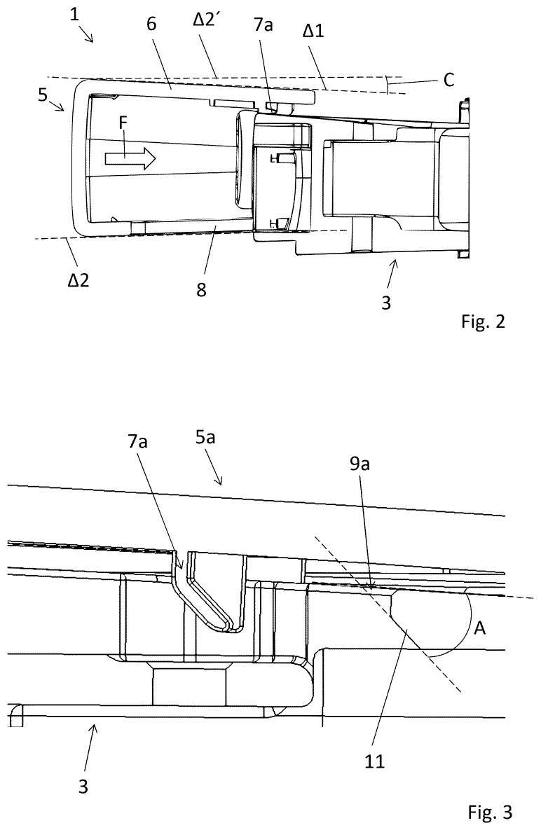

The handle 1 also comprises a cover 5, as represented in FIG. 1b, configured to be fastened to the structure 3. The cover 5 may be slid around the structure 3 as represented by the arrow F in FIG. 2 in order to assemble the cover 5 to the structure 3.

The cover 5 may be made of plastic material. The cover 5 may have a U-shape cross-section with a first branch 6 of the U comprising a first arm 5a and second arm 5b. The first branch 6 of the U may be longer than the second branch 8.

The first and second branches 6, 8 of the U may extend towards each other with an angle C comprised between 5 and 30° for example 15°. In FIG. 2, the line Δ1 is aligned with the first branch 6, the line Δ2 is aligned with the second branch 8 and the lines Δ2 and Δ2′ are parallel so that the angle C is represented between the lines Δ1 and Δ2′.

The first arm 5a is configured for covering the first sleeve 3a and the second arm 5b is configured for covering the second sleeve 3b. The first arm 5a comprises a first hook 7a configured to be introduced in a first slot 9a arranged in a wall of the first sleeve 3a to ensure the alignment of the first arm 5a with the first sleeve 3a. The second arm 5b comprises a second hook 7b configured to be introduced in a second slot 9b arranged in a wall of the second sleeve 3b to ensure the alignment of the second arm 5b with the second sleeve 3b.

The first and second slots 9a, 9b are arranged in a wall of the respective first and second sleeves 3a, 3b of the structure 3 and the inner side of the edge of the wall associated with the first and second slots 9a, 9b defines a chamfer 11 with an angle A comprised between 20° and 60°, for example 45° with respect to the plane (or general direction) defined by the wall of the sleeve 3a, 3b as represented in FIG. 3. The chamfer 11 may be arranged only on a portion of the edge of the wall to avoid a slot 9a, 9b with a sharp edge.

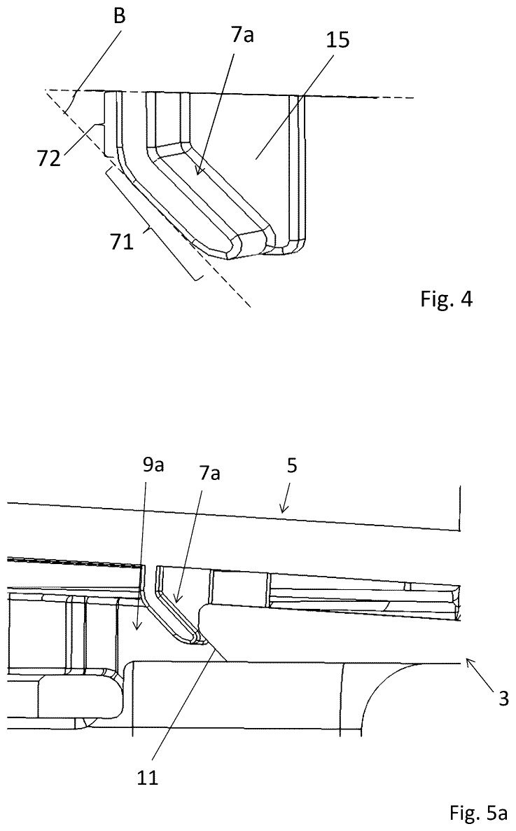

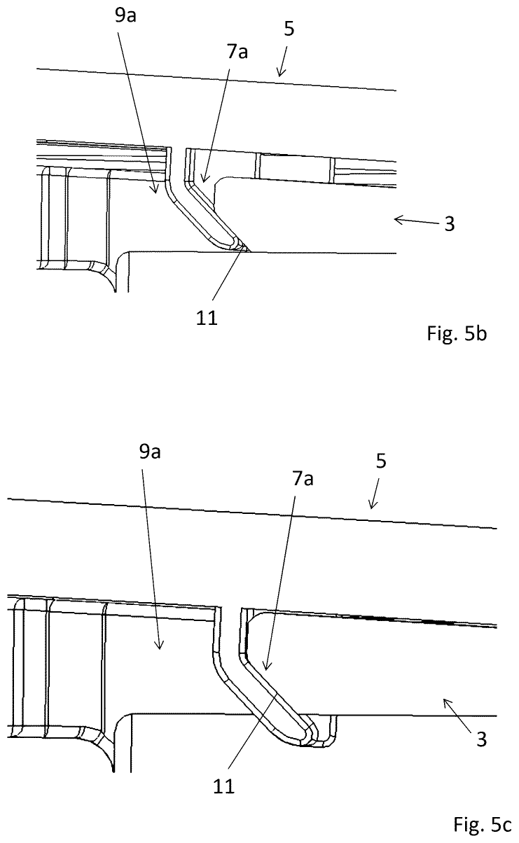

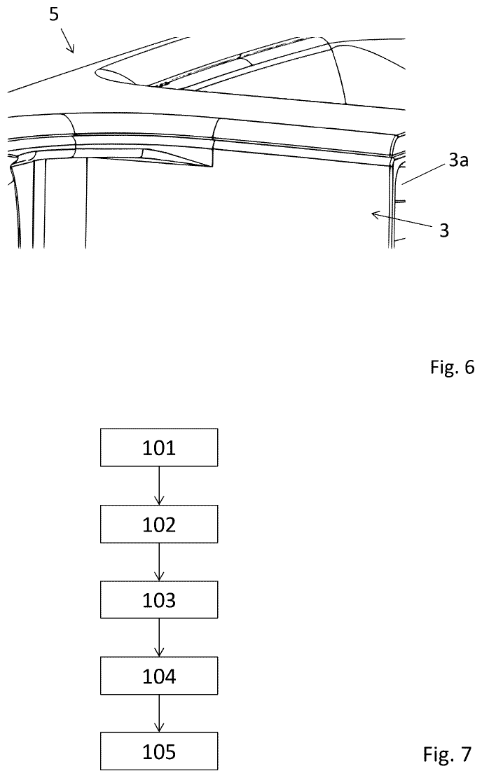

The first and the second hooks 7a, 7b have a shape complementary with the wall of the slots 9a, 9b and in particular with the respective chamfers 11. Thus, the first and second hooks 7a, 7b comprise a wall, herein called first portion 71, having a tilt B which is equals to the angle A and therefore comprised between 20° and 60°, for example 45° with respect to the plane (or general direction) defined by the arm 5a, 5b as represented in FIG. 4. The hooks 7a, 7b may comprise a second portion 72 extending perpendicular to the plane defined by the arm 5a, 5b in order to be complementary with the edge of the slot 9a, 9b. The use of such chamfers 11 for the slots 9a, 9b and such complementary shape of the hooks 7a, 7b cases the insertion of the hooks 7a, 7b within the respective slots 9a, 9b and prevents the fact that a hook 7a, 7b is not introduced in the associated slot 9a, 9b during the assembly of the cover 5 on the structure 3. As the insertion of the hooks 7a, 7b within the slots 9a, 9b is eased, the risk of a gap between the cover 5 and the structure 3 is reduced as the positioning of the hooks 7a, 7b at the bottom of the respective slots 9a, 9b ensure the right positioning of the cover 5 with respect to the structure 3 as represented in FIG. 6.

As shown in FIG. 4, the hooks 7a, 7b may also comprise a lateral wall 15 configured to reinforce the hooks 7a, 7b and to ease the manufacturing of the cover 5 by avoiding sharp edges.

According to other embodiments, the cover 5 may comprise a different number of hooks and the hooks may be arranged at other locations on the cover 5. The structure may then comprise a different number of slots associated with the respective hooks.

Furthermore, as represented in FIG. 1a, the structure 3 may comprise guiding rails 13 configured for guiding the hooks 7a, 7b of the cover 5 towards the slots 9a, 9b when the cover 5 is slid around and along the structure 3. The guiding rails 13 may be made by material removal and may be arranged along the first and the second sleeves 3a, 3b.

The handle 1 may also comprise clipping means between the cover 5 and the structure 3. The clipping means may be achieved by hooks arranged on flexible arms of the cover 5 and slots arranged in the structure 3, the slots being configured for receiving the hooks upon flexion of the flexible arms. The clipping means are configured for clipping the cover 5 to the structure when the hooks 7a, 7b are positioned in the bottom of the slots 9a, 9b as represented in FIG. 4c. The clipping means are configured to restrain the cover 5 against the structure 3 when the hooks 7a, 7b are positioned in the bottom of the slots 9a, 9b.

Alternatively or in addition to the clipping means, the cover 5 may be glued to the structure 3 to ensure the fastening of the cover 5 to the structure 3.

The present invention also refers to a vehicle door handle assembly comprising a bracket configured to be fixed on an inner side of a vehicle door panel and a door handle 1 as described previously.

The present invention also refers to a method for assembling a vehicle door handle 1 as described previously.

FIG. 7 represents a flowchart of the different steps of the method.

The first step 101 refers to the positioning of the cover 5 next to the structure 3 with the first and second hooks 7a, 7b positioned respectively in front of the first and second slots 9a, 9b.

More specifically, the first and second hooks 7a, 7b are positioned at a first end of the guiding trails 13 of the structure 3, the slots 9a, 9b of the structure 3 being located at the other end of the guiding trails 13.

The second step 102 refers to the sliding of the cover 5 along the structure 3 in order for the first 7a and second 7b hooks of the cover 5 to be introduced or inserted in the respective first 9a and second 9b slots of the structure 3. The hooks 7a, 7b are guided by the guiding trails 13 during the sliding. FIGS. 4a, 4b and 4c represent different stages of the insertion of a hook 7a within a slot 9a at the end of the sliding. Thanks to the particular shape of the hook 7a and the slot 9a described previously, the end of the hook 7a is guided along the chamfer 11 towards to the bottom of the slot 9a so that the cover 5 is pushed against the structure 3 ensuring the absence of gap between the cover 5 and the structure 3 when the end of the hook 7a, 7b reaches the bottom of the slot 9a, 9b as represented in FIG. 6.

The third step 103 refers to the clipping of the cover 5 to the structure 3 to fasten the cover 5 to the structure 3 and prevents the cover 5 from sliding in the opposite direction as the direction of the sliding step 102.

The fourth step 104 is an optional step and refers to the gluing of the cover 5 to the structure 3 to reinforce the fastening of the cover 5 to the structure 3. The glue may be applied on the structure 3 and/or on the cover 5 before the sliding step 102.

Thus, thanks to the use of slots 9a, 9b with an internal chamfer 11 arranged on the structure 3 and associated hooks 7a, 7b arranged on the cover 5 and having a complementary shape, a correct assembly of the cover 5 on the structure 3, without gap, may be ensured in an easy step of sliding the cover 5 around the structure 3.

1-10. (canceled)

11. A vehicle door handle configured to be fastened to a bracket fixed on an inner side of a vehicle door panel, the door handle being configured for moving between a retracted position in which the door handle is flush with an outer side of the vehicle door panel and a deployed position, the door handle comprising:
a structure comprising a first sleeve configured to be fastened to a first lever of the bracket and a second sleeve configured to be fastened to a second lever of the bracket; and
a cover configured to be fastened to the structure, the cover comprising a first arm configured to cover the first sleeve and a second arm configured to cover the second sleeve,
wherein the first arm comprises a first hook configured to be introduced in a first slot arranged in a wall of the first sleeve to ensure the alignment of the first arm with the first sleeve and the second arm comprises a second hook configured to be introduced in a second slot arranged in a wall of the second sleeve to ensure the alignment of the second arm with the second sleeve, the inner side of the wall associated with the first slot of the first sleeve and with the second slot of the second sleeve defining a chamfer with an angle comprised between 20° and 60°, and
wherein the first hook and the second hook have a shape complementary with the respective chamfers to ease the introduction of the first and second hooks within the respective first and second slots.

12. The vehicle door handle in accordance with claim 11, wherein the angle of the chamfer is 45°.

13. The vehicle door handle in accordance with claim 11, wherein the cover has a U-shape cross section with a first branch of the U comprising the first arm and the second arm of the door handle and a second branch opposing the first branch, the first and second branches of the U extending towards each other with an angle comprised between 5 and 30°.

14. The vehicle door handle in accordance with claim 13, wherein the first branch of the U is longer than the second branch.

15. The vehicle door handle in accordance with claim 11, wherein the structure and the cover comprise clipping means for fastening the cover to the structure.

16. The vehicle door handle in accordance with claim 11, wherein the cover is glued to the structure.

17. The vehicle door handle in accordance with claim 11, wherein the structure comprises guiding rails configured to guide the hooks of the cover towards the slots during assembly.

18. The vehicle door handle in accordance with claim 11, wherein the cover is made of plastic material.

19. A vehicle door handle assembly comprising:
a bracket configured to be fixed on the inner side of a vehicle door panel; and
the vehicle door handle in accordance with claim 11,
wherein the bracket comprises a first and a second levers configured to receive the first and second sleeves of the structure of the door handle.

20. A method for assembling the vehicle door handle in accordance with claim 11, the method comprising the following steps:
positioning the cover next to the structure with the first and second hooks positioned respectively in front of the first and second slots;
sliding the cover along the structure to introduce the first and second hooks of the cover in the respective first and second slots of the structure; and
clipping the cover to the structure.

21. The method in accordance with claim 20, wherein the structure comprises guiding rails to guide the hooks of the cover towards the slots during assembly and, during the sliding step, the hooks of the cover are displaced along the guiding rails towards the respective first and second slots of the structure.
